(19) United States
(12) Patent Application Publication
(10) Pub. No.: US 2005/0206189 A1
(43) Pub. Date: Sep. 22, 2005

(54) Protective blind for excavator windows

(76) Inventor: Laurie Gibson, Penhold (CA)

Correspondence Address: THOMAS E. MALYSZKO, SUITE 700, 205 - 5 AVENUE, S.W., CALGARY, AB, T2P 2V7, CA

(21) Appl. No.: 11/068,336

(22) Filed: Mar. 1, 2005

Related U.S. Application Data
(60) Provisional application No. 60/553,938, filed on Mar. 18, 2004.

(30) Foreign Application Priority Data
Mar. 17, 2004 (CA) 2,4612,49

(51) Int. Cl. B60J 1/20

(52) U.S. Cl. 296/98

(57) ABSTRACT

Windows of a vehicle can be quickly and efficiently protected from projectiles through a cover material and buffer zone combination. In a system aspect, the system comprises: a cover material, cover-material rolling means, mounting means suitable for mounting said rolling means to the vehicle and tensioning means suitable for applying a tension to the cover material. When the rolling means is mounted on the vehicle using said mounting means and the cover material is unrolled to cover the window and the tensioning means applies a tension across the cover material, a buffer zone results between said cover material and said window. A method aspect is also provided.

### CROSS REFERENCE TO RELATED APPLICATION

This application is a regular application of U.S. Provisional Patent Application Ser. No. 60/553,938 filed Mar. 18, 2004 and entitled, “PROTECTIVE BLIND FOR EXCAVATOR WINDOWS”, the entirety of which is incorporated herein by reference.

### FIELD OF THE INVENTION

This invention relates generally to vehicle accessories and, more particularly, to vehicle windshield covers.

### BACKGROUND OF THE INVENTION

When transporting vehicles, flying rocks and debris often cause damage to the windshields of such vehicles. This is especially a problem when transporting excavators or backhoes, which have fairly extensive windshields, are often simply placed on a transport truck and travel at fairly significant velocities on such transport trucks, and hence are subjected to various flying debris and rock along the transport route.

Covers, which are sheets of plastic or metal material and that can be temporarily mounted in front of the windshields of vehicles such as excavators, are one proposed solution to the aforementioned problem. Although useful, the inventor herein has determined that such covers are inconvenient because a significant amount of effort is required to place such covers in front of the windshields prior to transport, and remove them thereafter. Additionally, in a construction site scenario such cover are often lost or misplaced.

Applicant is not aware of permanently mounted vehicular windshield cover, suitable for protecting the windshield of a vehicle from rocks and other debris during transport, that is simple to operate, has minimal moving parts and can be easily and inexpensively manufactured and installed.

### SUMMARY OF THE INVENTION

In one aspect of the invention there is provided a window cover system for protecting a window of a vehicle from projectiles. The system comprises a cover material which is rollable up on a shaft of a blind and rollable off the shaft of the blind, mounting means suitable for mounting the blind to the vehicle; and tensioning means suitable for applying a tension to the cover material. When the blind is mounted on the vehicle using said mounting means and the cover material is unrolled to cover the window and the tensioning means applies a tension across the cover material, a buffer zone results between said cover material and said window.

In one embodiment of the above aspect, the tensioning means comprises a spring to impart torque to the shaft and cover material hold-down means. In another embodiment, the tensioning means comprises a crank and ratchet system to impart torque to the shaft and cover material hold-down means.

In another aspect of the invention, there is provided a method of protecting a window of a vehicle from projectiles. The method comprises providing a cover material which is rollable up on a shaft of a blind and rollable off the shaft of the blind, mounting the blind to the vehicle, unrolling the cover material so as to cover the window, and applying a tension to the cover material so as to create a buffer zone between the cover material and the window.

In a broader aspect of the invention, there is provided a window cover system for protecting a window of a vehicle from projectiles. The system comprises a cover material, cover-material rolling means, mounting means suitable for mounting said rolling means to the vehicle and tensioning means suitable for applying a tension to the cover material. When the rolling means is mounted on the vehicle using said mounting means and the cover material is unrolled to cover the window and the tensioning means applies a tension across the cover material, a buffer zone results between said cover material and said window.

Preferably the buffer zone is in the range of 2 to 6 inches.

### BRIEF DESCRIPTION OF THE DRAWINGS

FIG. 1 is a front view of one embodiment of the invention mounted or installed on an excavator;

FIG. 2 is a front view of the embodiment of FIG. 1, wherein the blind is pulled down approximately half-way;

FIG. 3 is a front view of the embodiment of FIG. 1, wherein the blind is pulled down all the way so as to cover the front windshields of the excavator;

FIG. 4 is a side view of the embodiment of FIG. 1, wherein the blind is pulled down all the way so as to cover the front windshields of the excavator;

FIGS. 5a-5l are various components of the cover-material rolling means and the cover tensioning means of the embodiment of FIG. 1;

FIGS. 6a and 6b are side and top views respectively of one embodiment of a mounting bracket, suitable for mounting the invention to a Hitachi or John Deere excavator;

FIGS. 7a and 7b are side and top views respectively of another embodiment of a mounting bracket, suitable for mounting the invention to a Caterpillar model 300 series excavator;

FIGS. 8a-8c are top, rear and side views respectively of a third embodiment of a mounting bracket, suitable for mounting the invention to a Komatsu model 400 series excavator;

FIG. 9 is a side view of another embodiment of the invention, wherein the blind is pulled down all the way so as to cover the front windshields of the excavator;

FIGS. 10a and 10b are top and side views respectively of a spacer bar;

FIGS. 11a and 11b are side views of two alternate embodiments of cover material hold-down means;

FIGS. 12a-12k are various views of an embodiment of a cover tensioning means comprising a crank and ratchet system; and

FIGS. 13a-13j are perspective views of various components of the embodiment of FIG. 1.

### DETAILED DESCRIPTION OF THE PREFERRED EMBODIMENTS

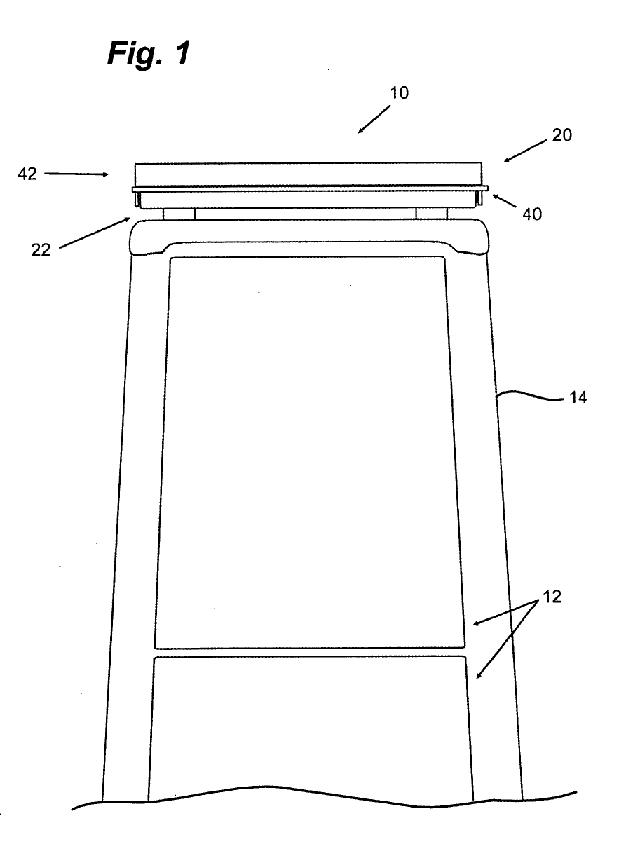

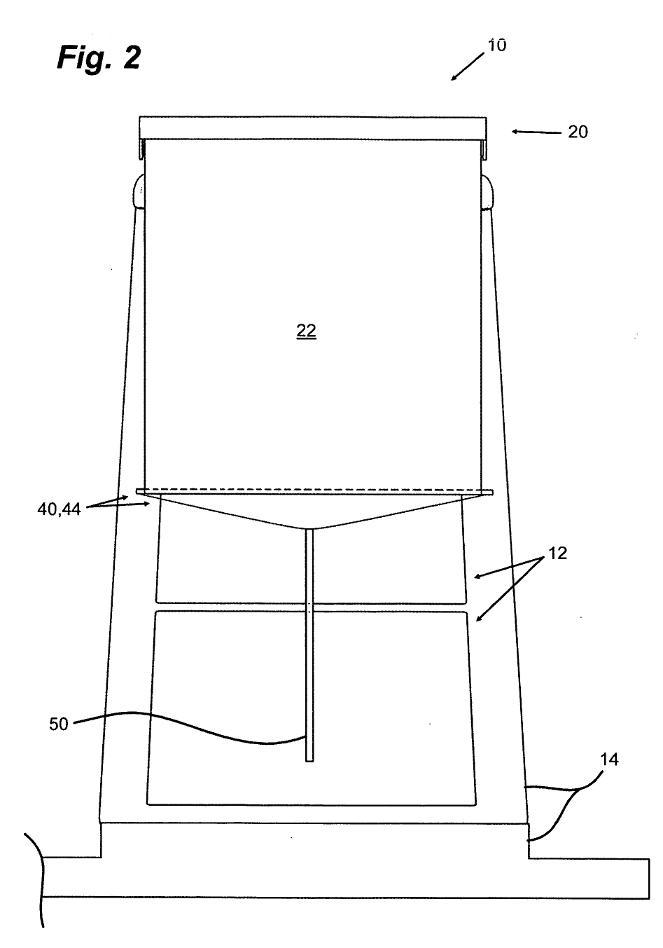

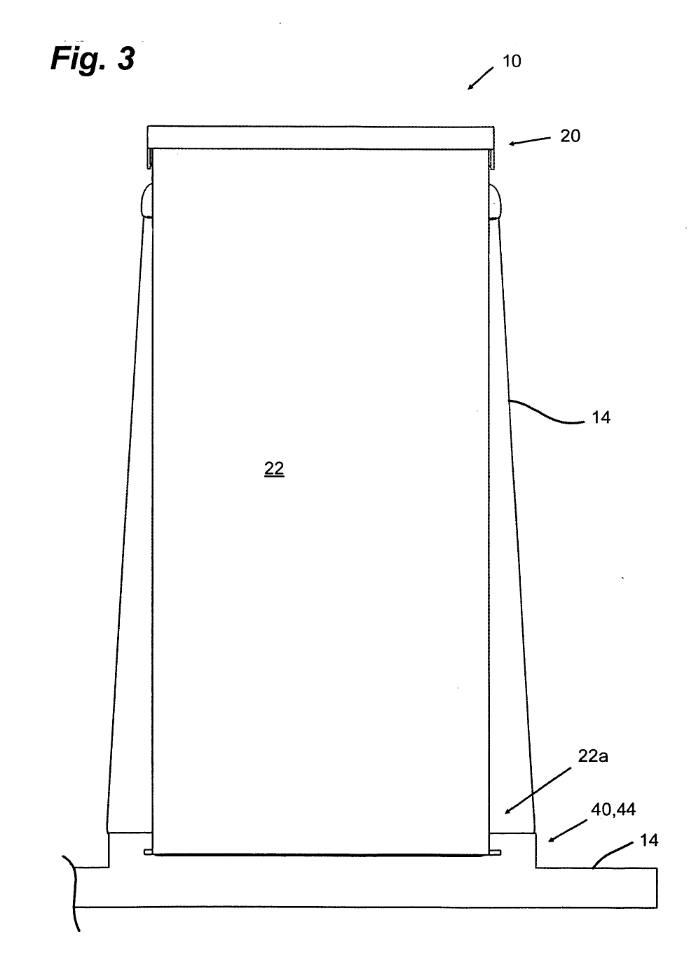

Generally, and referring to FIGS. 1-4, a preferred embodiment of a permanently mounted vehicular windshield cover 10 is shown for protecting the windshield 12 of a vehicle 14, such as an excavator, from rocks and other debris (not shown) during transport on a transport vehicle (not shown). The windshield cover 10 comprises cover-material rolling means 20, cover material 22, cover mounting means 30, and cover tensioning means 40. Preferably, the windshield cover 10 further comprises cover material pulling means 50.

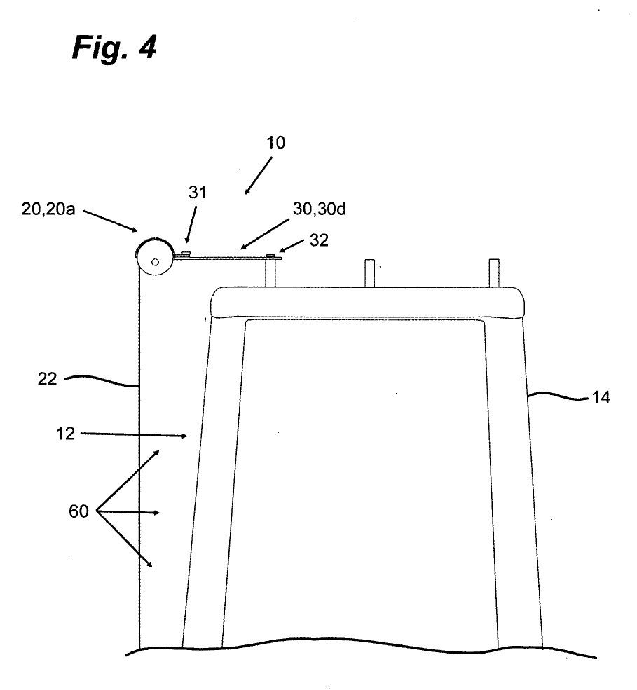

In operation, the windshield cover 10 is mounted on the vehicle 14 via the mounting means 30 such that when the cover material 22 is unrolled from the rolling means 20, and thus covering the windshield 12, a space, passage or buffer zone 60 results between the cover material 22 and the windshield 12 (as more clearly seen in FIG. 4). An optimal space or buffer zone 60 is a distance in the range of 2 to 6 inches between cover material 22 and the windshield 12.

Further in operation, the cover tensioning means 40 apply a tension across the cover material 22 which causes the cover material 22 to absorb the impact of a rock or other debris (not shown) across all or part of the buffer zone 60, such impact otherwise having hit the windshield 12. Advantageously, the cover material 22 when unrolled to cover the windshield 12 and tensioned by the tensioning means 40 reflects rocks and other debris.

Although the cover rolling means 20 is shown mounted on the top of the vehicle 14, it could also be mounted near the bottom of the vehicle 14 or on one of the sides of the vehicle 14.

More specifically, and referring to FIGS. 1-5l, the cover tensioning means 40 further comprise a spring-driven cover roller 42 attached to the rolling means, and cover material hold-down means 44 located near that end of the windshield 12 opposite to where the cover 10 is mounted and suitable for engaging the free end 22a of the cover material. In this embodiment tension is created across the cover material 22 when a spring-driven cover roller 42 attempts to roll up the cover material 22 on the cover rolling means 20 (much like a window blind, when actuated, attempts to roll up the window blind) while the hold-down means 44 engage the free end 22a of the cover material 22 preventing the cover material 22 from rolling up.

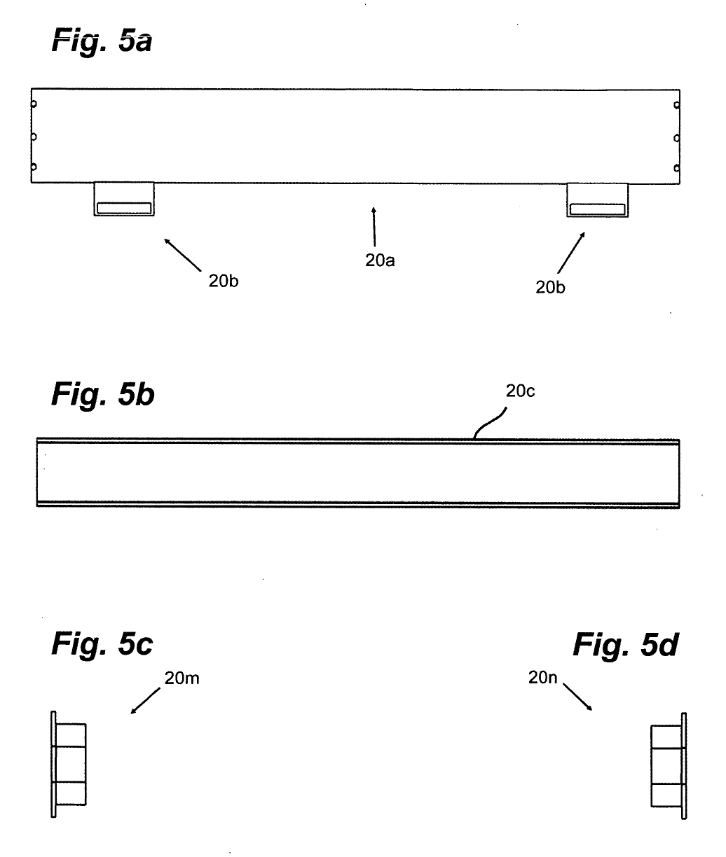

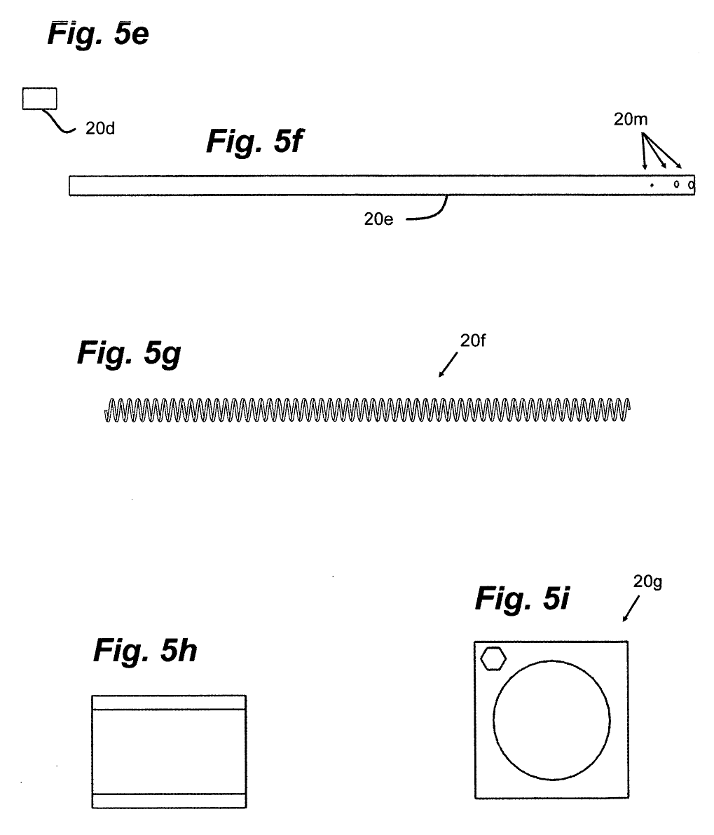

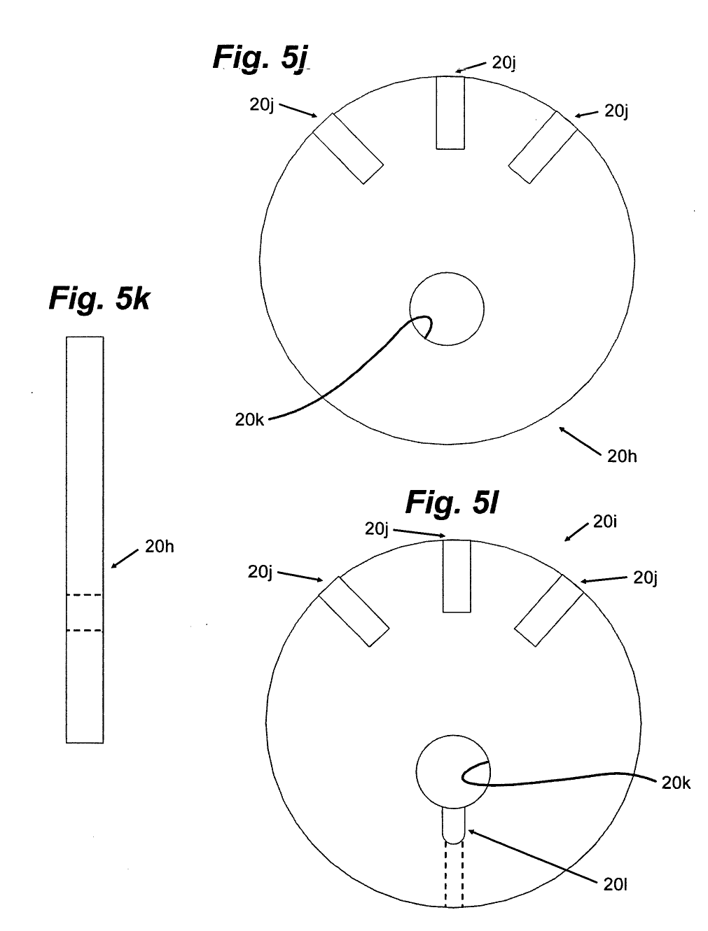

Referring to FIGS. 5a-5l, the rolling means 20 and tensioning means 40 of the preferred embodiment comprise the following:
a 36 inch long shell 20a having bracket engaging tabs 20b (FIG. 5a), preferably made from metal, stainless steel, or plastic;
a hollow square-shaped cover-roller-shaft 20c preferably made from 2″ square steel tubing (FIG. 5b);
two shaft pieces 20d, 20e preferably made from ¾″ diameter round aluminum (FIGS. 5e and 5f);
end caps 20m, 20n (FIGS. 5c and 5d) into which the shaft pieces 20d, 20e fit and which in turn engages the ends of the cover roller 20c, preferably the end caps 20m, 20n are made from plastic;
a spring 20f (FIG. 5g);
a square shaped spring end 20g (FIG. 5i), preferably made of plastic; and
end pieces 20h, 20i (FIGS. 5j-5l), preferably made of metal, and each having three set screw holes 20j and a shaft receiving opening 20k.

When assembled, end pieces 20h, 20i attach to the ends of the shell 20, and the end caps 20m, 20n attach to the ends of the square shaft 20c. Further, the ends of the shafts 20d, 20e protrude through the end caps 20m, 20n and engage the shaft receiving opening 20k of the end pieces 20h, 20i; thereby rotatably supporting the square shaft 20c between the end pieces 20h, 20i. The spring 20f slides over the shaft piece 20e. One end of the spring 20f attaches to shaft piece 20e at one of three points 20m (depending on the desired spring tension) and at the other end attached to the square spring end 20g which attaches to the other end of the shaft piece 20e. The spring 20f and spring end 20g are therefore also inside the hollow square shaft 20c, with the square spring end 20g sized so as to engage the square inner walls of the hollow square shaft 20c. One of the end pieces 20i, further comprises a groove 20L for receiving a set screw (not shown) to lock the shaft piece 20e in place.

Thus in operation, the shaft 20e and spring end 20g float inside the square hollow shaft 20c with the spring end 20g sliding back and forth inside and along the axis of the shaft 20c as assembly is rotated thereby imparting or relieving torque to the shaft 20c.

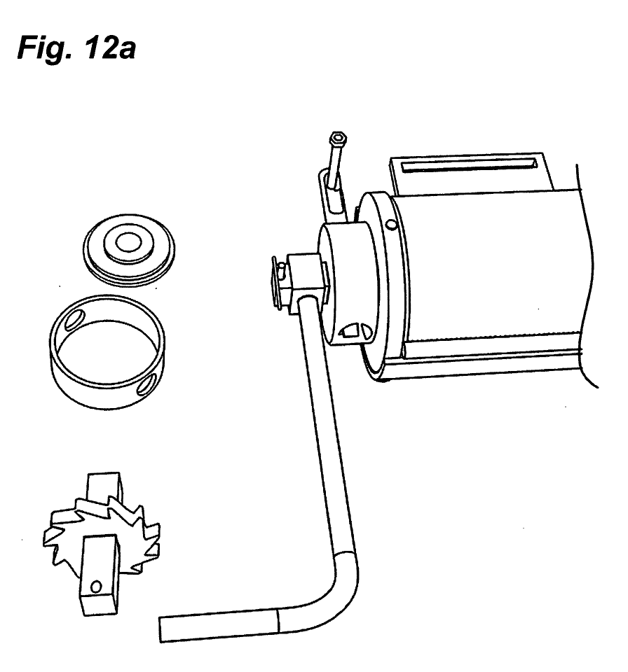

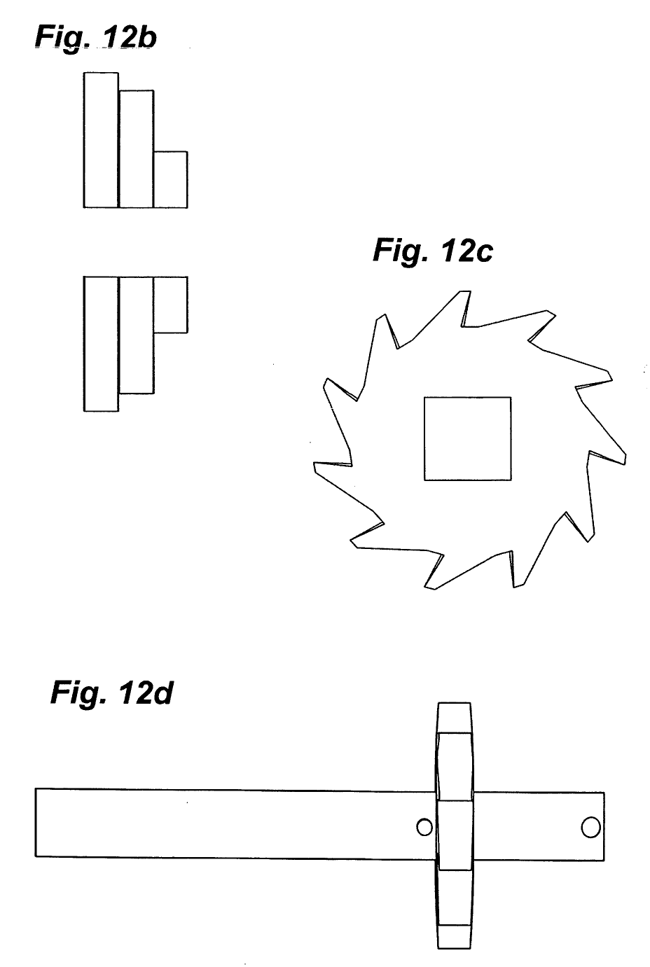

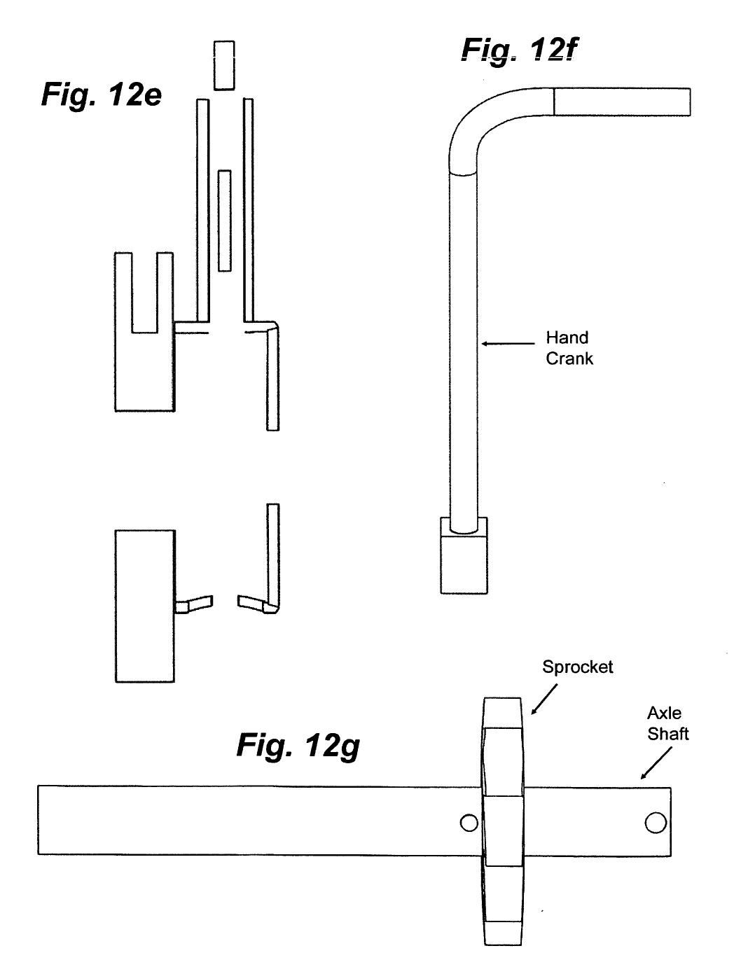

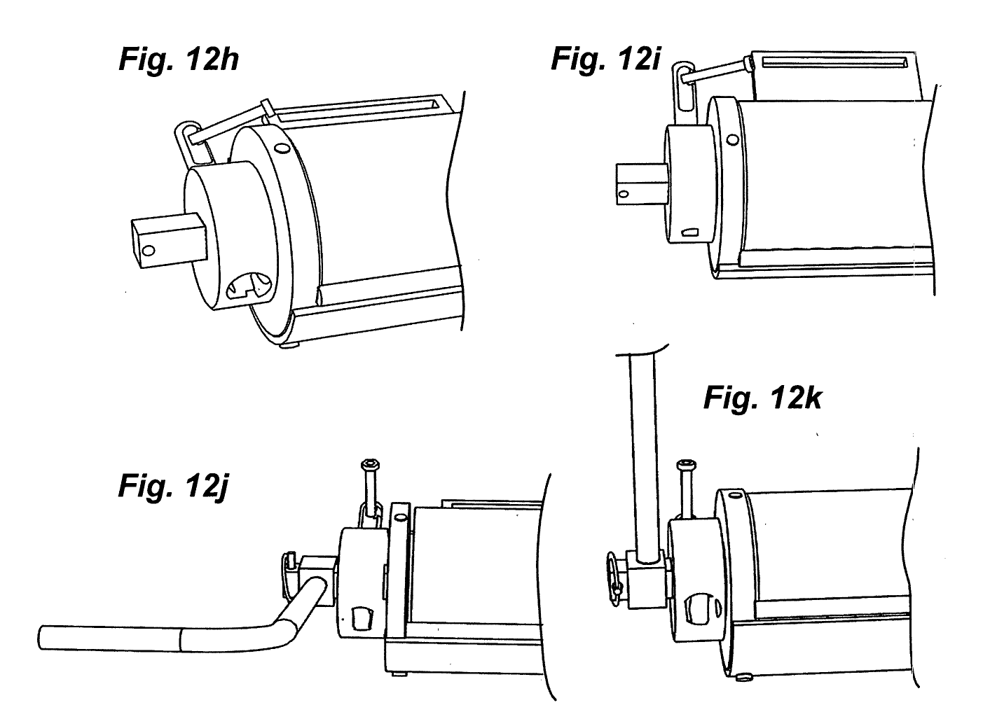

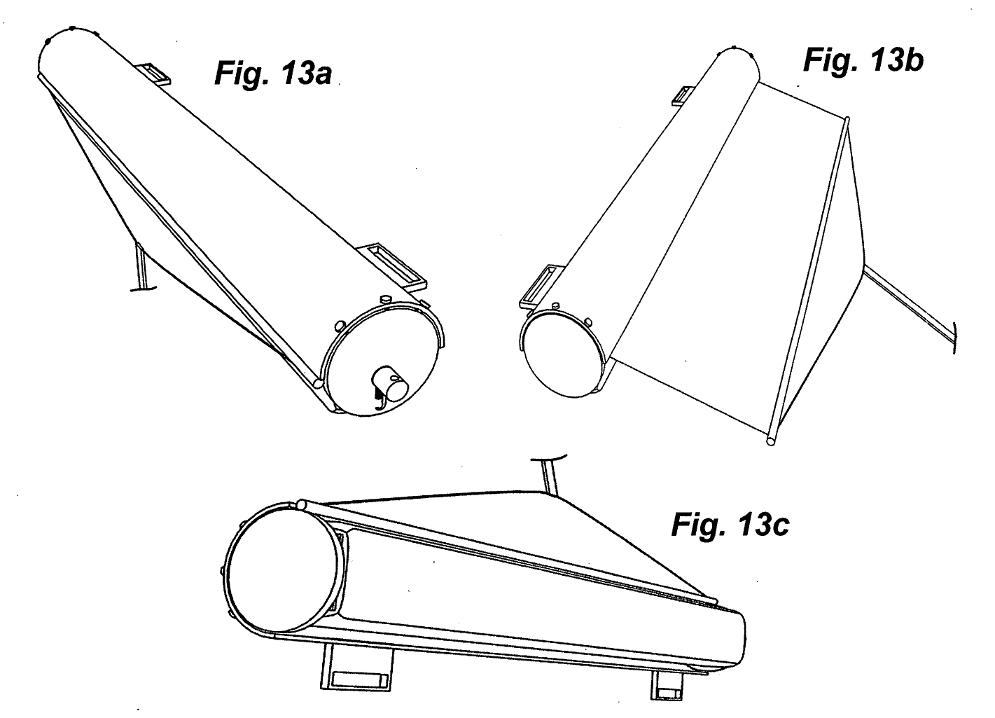

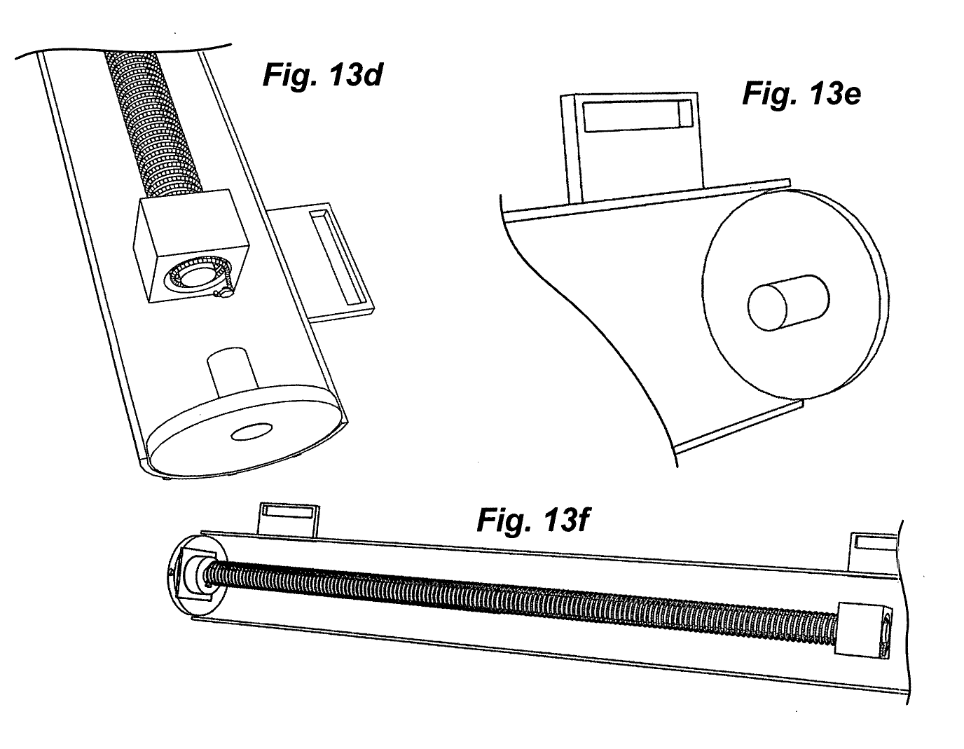

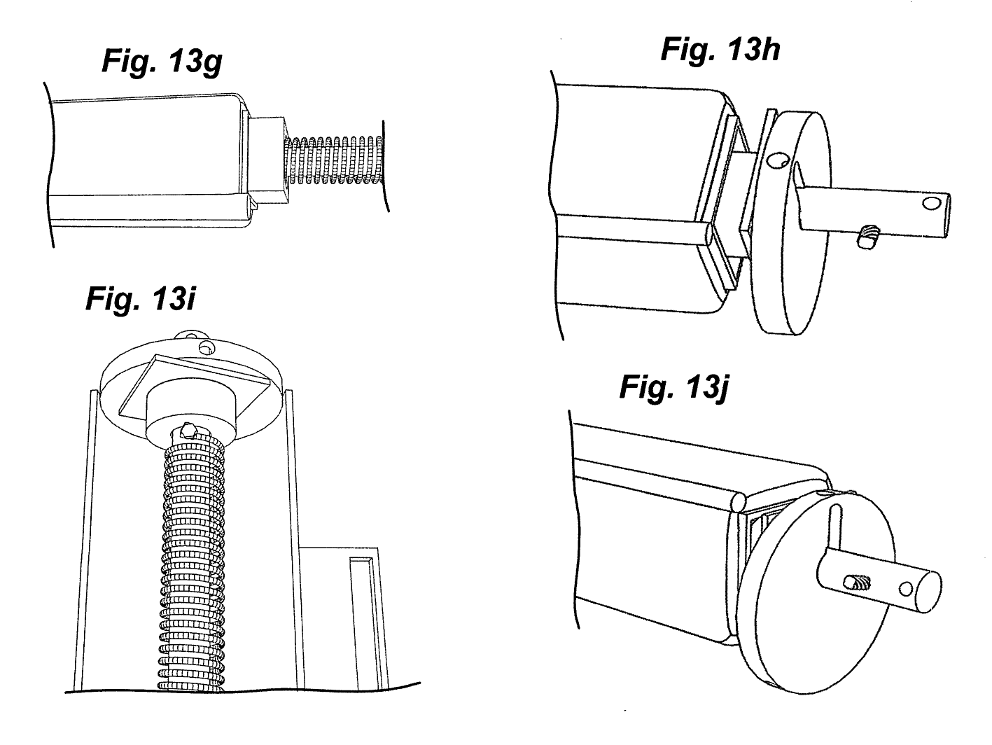

Alternatively, in another embodiment, the cover tensioning means 40 may further comprise a crank and ratchet system wherein the cover material 22 is unrolled from the rolling means 20, the free end 22a is engaged by hold-down means 44 and the crank and ratchet system are then employed to draw tension across the cover material 22. Crank and ratchet systems are well known in the art and one embodiment of such a system in shown in FIGS. 12a-12k.

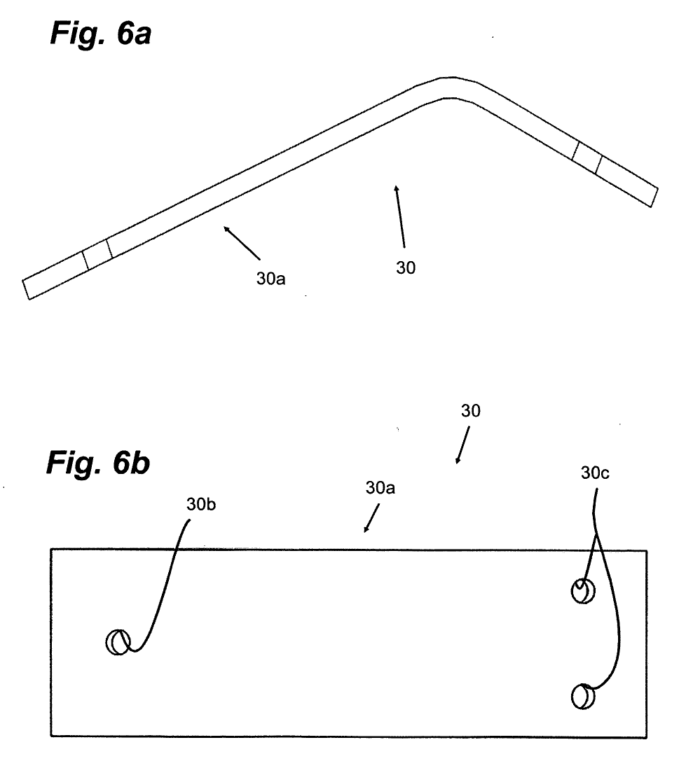

In one embodiment, and now referring to FIGS. 6a-6b, the mounting means 30 comprises a pair of angular brackets 30a each measuring 6 inches by 2 inches by ¼ inch thick and angled at approximate 65° as shown (see FIG. 6a). A ¾ inch hole 30b is drilled through the bracket at one end, as shown, and a pair of 33/64 inch holes is drilled through the bracket at the other end, as shown. The single hole 30b is suitable for mounting the bracket on the light brackets on the roof of a cab of a Hitachi or John Deere excavator, via bold means (not shown). The pair of holes 30c are suitable for mounting the bracket to the bracket engaging tabs 20b of the shell 20a of the preferred embodiment of the invention, via nut and bold means (not shown).

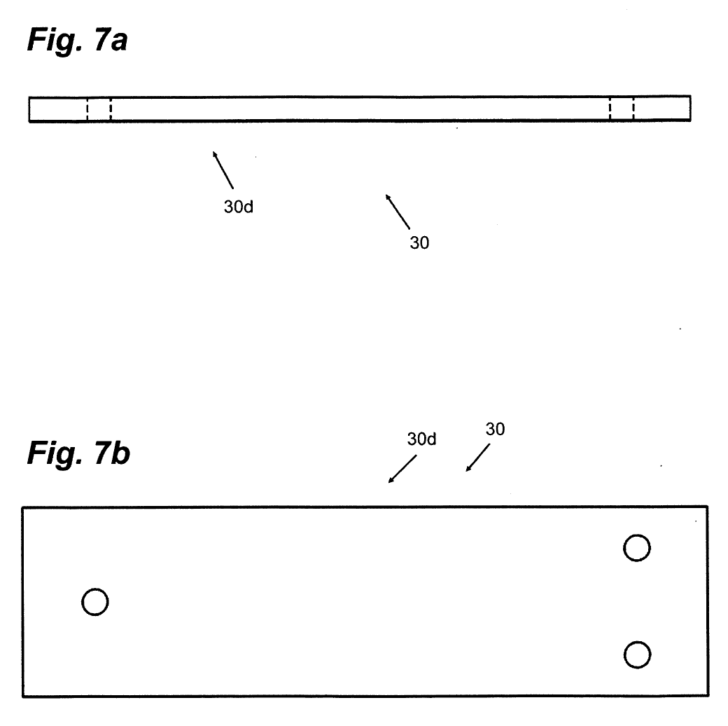

In a second embodiment, and now referring to FIGS. 4 and 7a-7b, the mounting means 30 comprises a pair of planar brackets 30d with similar holes and dimension to those of the angular brackets of FIGS. 6a-6b, with the exception of being 8 inches long (as opposed to 6 inches long). Such a pair of brackets are suitable mounting means 20 to mount the invention to a Caterpillar model 300 series excavator. The pair of brackets 30d may be fastened to the shell 20a and its tabs 20b by nut and bolt means 31. The pair of brackets 30d may be further fastened to the vehicle 14 by bolt means 32.

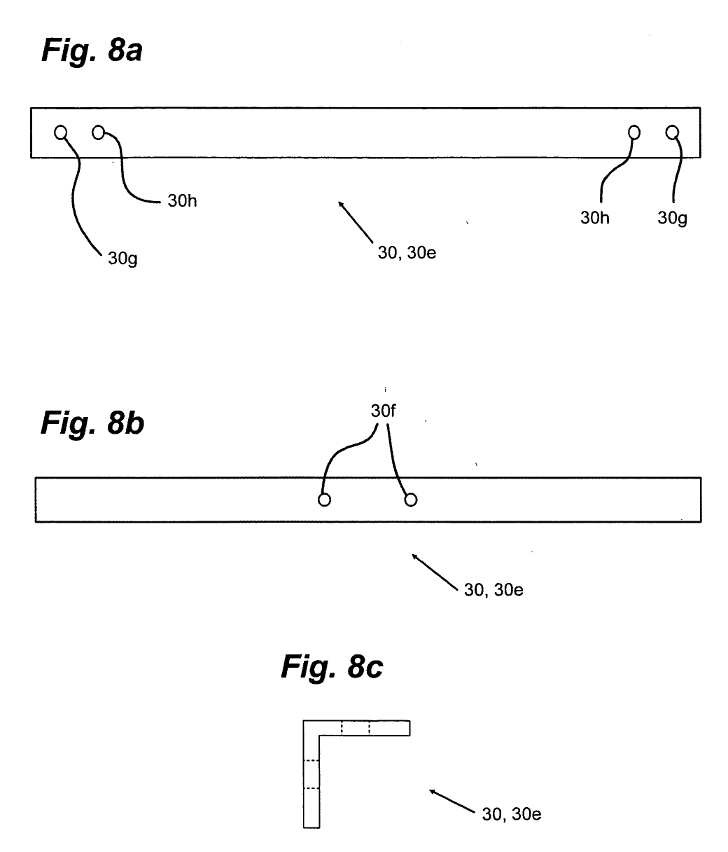

In a third embodiment, and now referring to FIGS. 8a-8c, the mounting means 30 comprises a single bracket 30e. In this embodiment the single bracket 30e is a 36 inch long piece of aluminum angle iron, with 2 inch sides joined at 90° to relative each other, wherein a pair of 3/8 inch diameter holes 30f are drilled through near the center of one of the sides and as shown in FIG. 8b, the holes 30f spaced 14 inches apart center to center, and further wherein a pair of 33/64 inch diameter holes 30g, 30h are drilled through at each end of the other side and as shown in FIG. 8a, the holes 30g spaced 1 inch from the ends and the holes 30h spaced 2 inches center to center from holes 30g. The pair of holes 30g, 30h at each end are suitable for mounting the bracket to the bracket engaging tabs (not shown) of the shell (not shown) of the preferred embodiment of the invention, via nut and bold means (not shown). This mounting bracket 30e is suitable for mounting the invention to a Komatsu model 400 series excavator which has a pair of holes on the top front of its cab which match the 14 inch center-to-center spacing of the holes 30f.

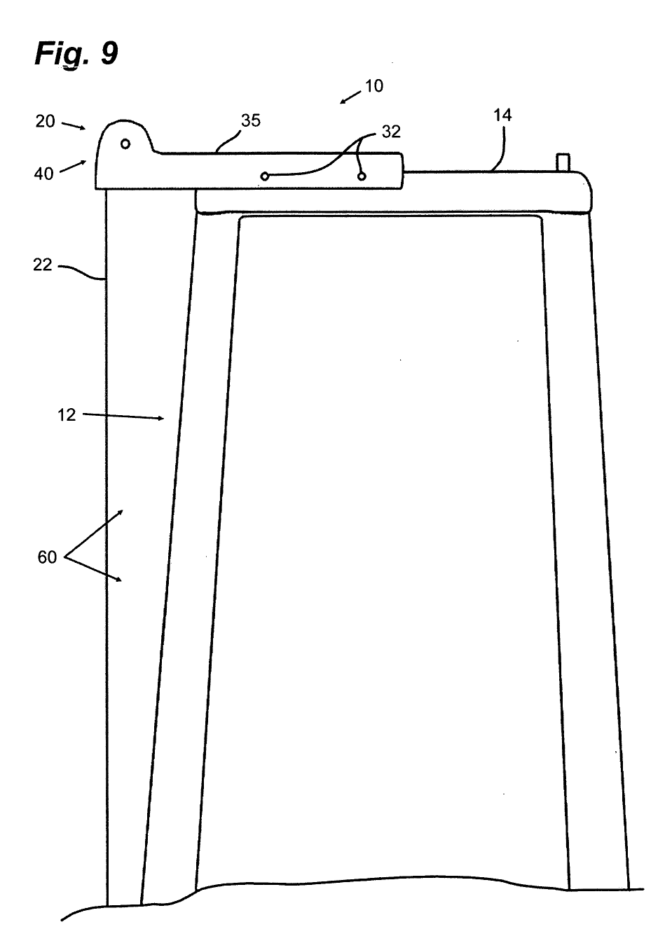

Referring now to FIG. 9, an alternate embodiment a permanently mounted vehicular windshield cover 10 is shown for protecting the windshield 12 of a vehicle 14 from rocks and other debris (not shown) during transport on a transport vehicle (not shown). The windshield cover 10 comprises cover material rolling means 20, cover material 22, cover mounting means 30, and cover tensioning means 40. In this embodiment, the cover mounting means 30 comprises a pair of 3/8 inch thick metal plates 35 shaped as shown and placed edgewise, one on each side of the top of the cab of the vehicle 14. The plates 35 are attached to the vehicle via bolt means 32. The rolling means 20 is therefore mounted between the pair of plates 35.

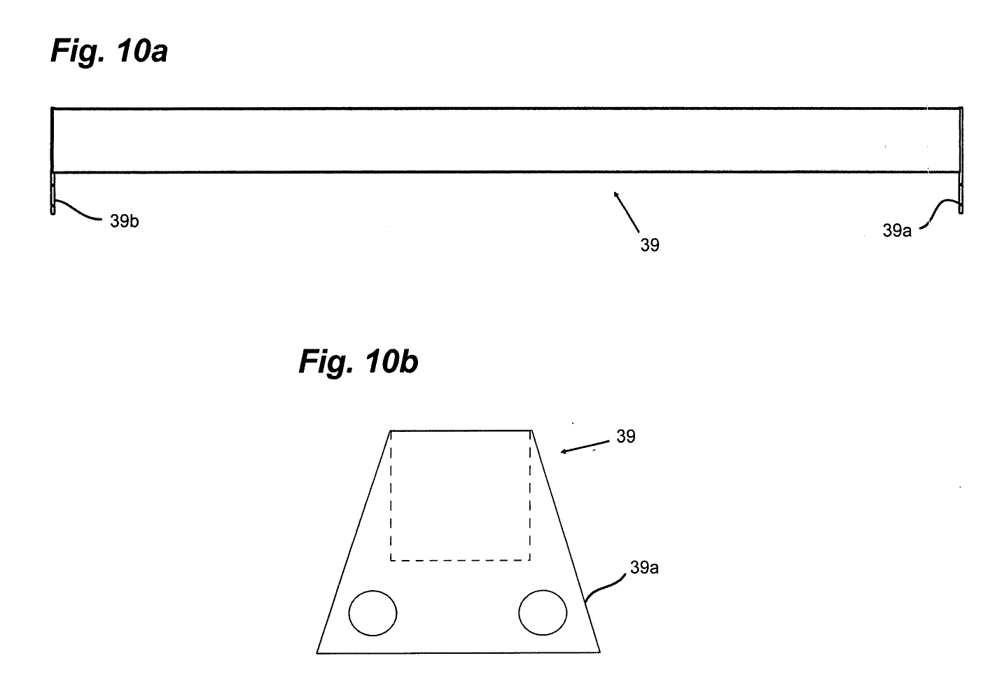

Referring to FIGS. 10a-10b, in yet another embodiment and in cases where the windshield of an excavator may be curved, the mounting means 30 further comprises a spacer bar 39 having end brackets 39a, 39b. In this embodiment the spacer bar 39 measures approximately 35½ inches from the inside of one end bracket 39a, to the inside of the other end bracket 39b. Advantageously, the spacer bar 39 can be mounted to existing flanges on the front of an excavator's cab where the two windows of the windshield meet.

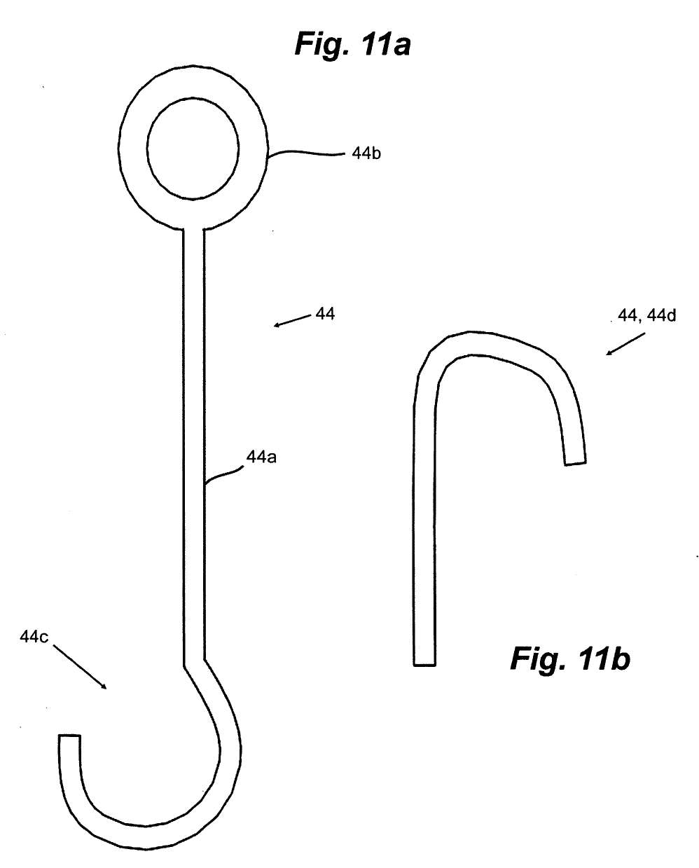

Referring now to FIGS. 11a and 11b two embodiments of cover material hold-down means 44 are shown. In FIG. 11a the hold-down means 44 further comprises a 6 inch long 1/8 inch steel cable 44a having an eye 44b on one end and a hook 44c on the other end. The eye 44b can be mounted to an excavator or other vehicle at the appropriate place while the hook 44c is used to engage and retain the free end 22a of the cover material 22. Preferably a pair of cables 44a is used. The length of cable 44a can vary depending on the style of excavator cab.

In FIG. 11b, in an alternate embodiment, the hold-down means 44 further comprises a clip 44d suitable for engaging and retaining the free end 22a of the cover material 22. The clip 44d can be mounted to an excavator or other vehicle at the appropriate place.

Suitable cover material 22 include swather canvas, canvas, conveyor belting material and a coated polyester material such as IP-18E from Inland Plastics Ltd. of Drumheller, Alberta, Canada.

1. A window cover system for protecting a window of a vehicle from projectiles, the system comprising:
a cover material which is rollable up on a shaft of a blind and rollable off the shaft of the blind;
mounting means suitable for mounting the blind to the vehicle; and
tensioning means suitable for applying a tension to the cover material;
wherein when the blind is mounted on the vehicle using said mounting means and the cover material is unrolled to cover the window and the tensioning means applies a tension across the cover material, a buffer zone results between said cover material and said window.

2. The system of claim 1 wherein the buffer zone is in the range of 2 to 6 inches.

3. The system of claim 1 wherein the tensioning means comprises a spring to apply torque to the shaft and material hold-down means.

4. The system of claim 1 wherein the tensioning means comprises a crank and ratchet system to apply torque to the shaft and cover material hold-down means.

5. The system of claim 1 wherein the blind further comprises bracket engaging tabs and wherein the mounting means comprises bolt means and at least one bracket.

6. The system of claim 3 wherein the blind further comprises bracket engaging tabs and wherein the mounting means comprises bolt means and at least one bracket.

7. The system of claim 1 wherein the mounting means comprises bolt means and a pair of edgewise oriented plates.

8. The system of claim 1 further comprising a spacer bar.

9. A method of protecting a window of a vehicle from projectiles, the method comprising:
providing a cover material which is rollable up on a shaft of a blind and rollable off the shaft of the blind;
mounting the blind to the vehicle;
unrolling the cover material so as to cover the window; and
applying a tension to the cover material so as to create a buffer zone between the cover material and the window.

10. The method of claim 9 wherein the buffer zone is in the range of 2 to 6 inches.

11. The method of claim 9 wherein the tension is applied by imparting torque to the shaft and preventing the cover material from rolling up onto the shaft.

12. The method of claim 11 wherein the torque is imparted by a spring.

13. The method of claim 11 wherein the torque is imparted by a crank and ratchet system.

14. The method of claim 9 further comprising providing a spacer bar.

15. A window cover system for protecting a window of a vehicle from projectiles, the system comprising:
a cover material;
cover-material rolling means;
mounting means suitable for mounting said rolling means to the vehicle; and
tensioning means suitable for applying a tension to the cover material;
wherein when the rolling means is mounted on the vehicle using said mounting means and the cover material is unrolled to cover the window and the tensioning means applies a tension across the cover material, a buffer zone results between said cover material and said window.

16. The system of claim 15 wherein the buffer zone is in the range of 2 to 6 inches.

17. The system of claim 15 wherein the rolling means comprises a blind, wherein the cover material is rollable up on a shaft of said blind and rollable off the shaft of said blind.

18. The system of claim 15 wherein the tensioning means comprises a spring to apply torque to the shaft and material hold-down means.

19. The system of claim 15 wherein the tensioning means comprises a crank and ratchet system to apply torque to the shaft and cover material hold-down means.

20. The system of claim 15 wherein the blind further comprises bracket engaging tabs and wherein the mounting means comprises bolt means and at least one bracket.

21. The system of claim 18 wherein the blind further comprises bracket engaging tabs and wherein the mounting means comprises bolt means and at least one bracket.

22. The system of claim 15 wherein the mounting means comprises bolt means and a pair of edgewise oriented plates.

23. The system of claim 15 further comprising a spacer bar.
